(19) United States
(12) Patent Application Publication
(10) Pub. No.: US 2026/0002049 A1
(43) Pub. Date: Jan. 1, 2026

(54) ADHESIVE MASONRY TAPE

(71) Applicant: Glen Guilbeau, Rotterdam, NY (US)

(72) Inventor: Glen Guilbeau, Rotterdam, NY (US)

(21) Appl. No.: 18/756,225

(22) Filed: Jun. 27, 2024

(51) Int. Cl. C09J 7/20; E04F 21/00

(52) U.S. Cl. CPC C09J 7/20; E04F 21/00; C09J 2203/346; C09J 2301/312

(57) ABSTRACT

An adhesive masonry tape for use in brick laying includes an elongated tape substrate with adhesive properties on one side and a first set of markings designating a joint thickness for mortar placement between bricks. A method for employing the adhesive tape in brick laying is further disclosed that includes laying the adhesive masonry tape on a wall or story pole.

### FIELD OF TECHNOLOGY

The subject matter disclosed herein relates generally to masonry. More particularly, the subject matter relates to a masonry adhesive tape for measuring the distance between bricks and mortar during bricklaying.

### BACKGROUND

The art of masonry, the construction technique of building structures using brick or stone has been around for thousands of years. The accuracy of brick placement is crucial in masonry, as it ensures the structural integrity and aesthetic appeal of the construction. However, conventional methods of brick laying involve a lengthy masonry ruler which presents several challenges. First, the physical size and weight of the ruler make it cumbersome to handle, especially in constrained or elevated work areas. This often leads to increased physical strain on the mason and can slow down the construction process significantly. Second, the act of unfolding and refolding the ruler for each measurement is time-consuming, impacting overall efficiency and productivity in construction projects. Furthermore, traditional rulers are prone to wear and tear, and their accuracy can diminish over time due to repeated use and exposure to harsh environmental conditions. This can lead to errors in measurement. There has been a growing need for a more efficient, reliable, and user-friendly method for measuring and laying bricks in masonry.

### SUMMARY

An adhesive masonry tape for use in brick laying includes an elongated tape substrate with adhesive properties on one side; and a first set of markings designating a joint thickness for mortar placement between bricks.

A method for employing adhesive masonry tape in brick laying includes providing an adhesive masonry tape, laying the adhesive masonry tape on a wall or story pole vertically, tearing off a desired length of the adhesive masonry tape, placing a first brick layer adjacent to the tape, laying a first layer of mortar above the first brick layer using the set of markings designating the joint thickness for mortar placement, placing a second brick layer above the first layer of mortar.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a perspective view of an adhesive masonry tape, in accordance with one embodiment.

FIG. 2 depicts an exploded view of the adhesive masonry tape in FIG. 1, in accordance with one embodiment.

FIG. 3 depicts an enlarged view of the adhesive masonry tape in FIG. 1, showing both a spacing marking and course identifier marking, in accordance with one embodiment.

FIG. 4 depicts a side schematic view of the adhesive masonry tape in FIG. 1, adhered to a wall, in accordance with one embodiment.

FIG. 5 depicts a perspective view of another adhesive masonry tape, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein relate to a device and method for significantly reducing the time and efficiency of the masonry process. Embodiments described herein relate to a masonry adhesive tape for measuring the distance between bricks and mortar during bricklaying. This masonry adhesive tape described herein may completely replace the need to use traditional brick mason wood ruler (i.e. Lufkin ruler). Further, the masonry adhesive tape described herein may obviate the need to spend time initially marking the wall for a masonry project and/or use a story pole to lay out a masonry project. Rather, the present masonry adhesive tape contemplates simply applying an appropriate height of the adhesive tape to a back wall and/or on a story poll in front of which bricks will be laid. Thus, embodiments described herein may significantly reduce the amount of time required to initiate the building of a masonry wall.

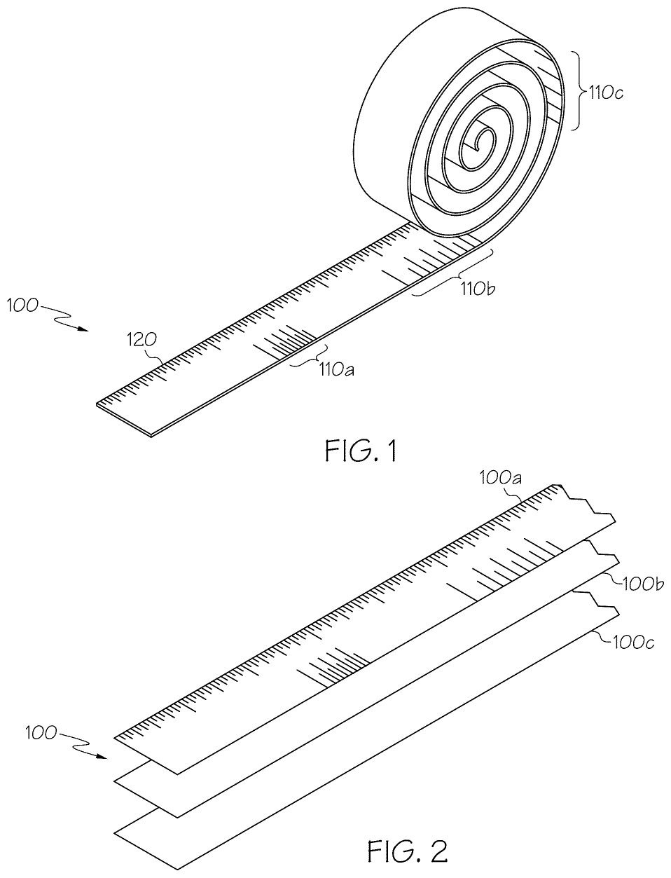

FIG. 1 depicts a perspective view of an adhesive masonry tape 100, in accordance with one embodiment. The adhesive masonry tape 100 is rolled into a spherical shape; however, the adhesive masonry tape 100 may also be conformed into various shapes for ease of packaging. The adhesive masonry tape 100 may be an elongated tape which is rolled and/or spun up into a roll which may be unrolled by a mason during use, as described herein below. The roll may be spun upwards or downwards with the printed content facing downwards or upwards. Various printing and tape rolling processes may be contemplated for rolling the adhesive masonry tape 100.

The adhesive masonry tape 100 may be configured to be flexible to bending but not stretchable. In other words, the adhesive masonry tape 100 may be configured to retain its lengthwise dimensions, even when subjected to unintentional and/or user-caused stretching forces. This may ensure the spacings are not altered during the application process and or usages and maintain proper brick spacing along the length of the adhesive masonry tape 100 when applied to a wall and/or story poll as described herein.

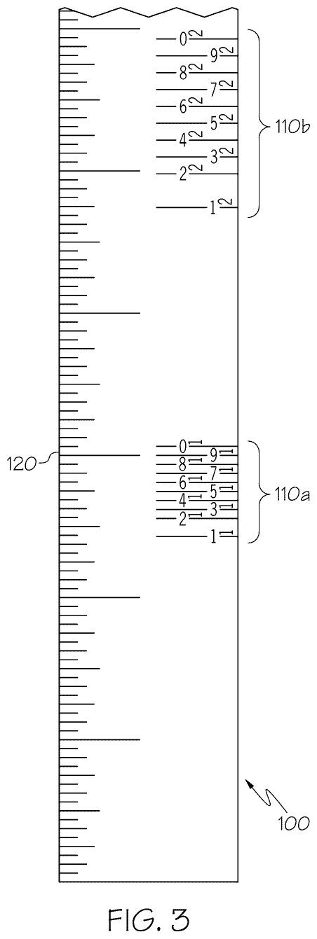

The adhesive masonry tape 100 is shown including two sets of markings: a first set of markings 110 and a second set of markings 120. The first set of markings 110 includes a plurality of subsets of markings 110a, 110b, 110c (generally 110) and extends from a right edge of the adhesive masonry tape 100. The first set of markings 110 designate markings for brick laying as described herein below. The first set of markings 110 is used to determine and/or facilitate a brick layer for maintaining consistency in the courses and amount of mortar between bricks. While the first set of markings 110 is shown extending from the right edge in the embodiment shown, in other embodiments the first set of markings 110 may extend from the left edge or extend across from both edges. The first set of markings 110 generally conforms to the markings that would be included on a traditional brick mason wood ruler (i.e. Lufkin ruler) and are shown more particularly in FIG. 3. The first set of markings 110 may be spaced for, and correspond to, any brick size or thickness. For example, the first set of markings 110 may be spaced in a standard format, an oversize joint thickness format, or modular spacing thickness format. Any brick laying format is contemplated, however. The standard brick spacing refers to a spacing used within the industry standard of 2¼ inch high bricks. The oversize spacing refers to a spacing used within the industry standard of 2¾ inch high bricks. The modular spacing refers to the layout of bricks based on modular sized bricks, used as a standard for some commercial constructions, for example.

Across the first set of markings 110, in particular extending from an opposing edge relative to the edge with the first set of markings 110 including a second set of markings 120. The second set of markings 120 indicates units of length, repeating every set designated number of units of length. The units of length may be, but not limited to, inches, feet, centimeters, or meters. The units of length may be any measurement unit's imperial or metric. In some embodiments, only the first set of markings 110 is included in the tape. However, it may be beneficial to also include the second set of markings 120 so that the adhesive masonry tape 100 is also capable of facilitating measurement in standard units of length.

The markings 110, 120 may be printed on the tape with solvent-based ink, water-based ink, UV-cured ink, thermal ink, and hot stamp ink. The ink may be formulated to resist smudging, running, or fading when exposed to water. To firmly adhere the ink to the tape substrate, the tape may be treated with surface treatments or primers to enhance the longevity and legibility of the printed measurements. The tape may be treated to enhance water resistance or waterproof properties.

FIG. 2 depicts an exploded view of a portion of the adhesive masonry tape 100 in FIG. 1, in accordance with one embodiment. Shown is a top printed tape substrate 100a on top of an adhesive layer 100b and a backing layer 100c. In combination, the tape where the tape substrate 200 with adhesive properties adhere to. The top printed tape substrate 100a may be made of materials not limited to those such as polypropylene, polyethylene, polyvinyl chloride, paper, cellophane, foam, rubber, and cellulose acetate. The adhesive layer 100b may be made of materials not limited to those such as acrylic adhesives, epoxy resins, rubber-based adhesives, silicone adhesives, polyurethane, and isocyanate adhesives. The backing layer 100c may be made of materials not limited to those such as paper, cloth, felt, foam, metal foil, plastic film/polymer, polyethylene terephthalate (PET)/polyester backing, polyimide, PVC/vinyl, rubber, silicone, acrylic films, glass/fiberglass, filament, and Fluoropolymer/PTFE/PVDF. The combination of the top printed tape substrate 100a and the adhesive layer 100b may together comprise a combination which can be easily torn by a user. In some embodiments, the adhesive tape 100 may be made of a water-resistant material.

FIG. 3 depicts a top view of a portion of the adhesive masonry tape 100 in FIG. 1, in accordance with one embodiment. Depicted is the first set markings 110, which is shown enlarged to display both a spacing number and a course number associated with each individual line of the markings 110. As shown, each of the first subset of markings 110a and the second subset of markings 110b includes ten individual lines. Each line includes two numbers: the left number is a spacing number (labeled one to zero) and the right sideways oriented number is a course number (all labeled 1 for the first subset of markings 110a and all labeled 2 for the second subset of markings 110b).

The term “course” herein is defined as a horizontal layer of building materials like masonry units or tiles applied to a building's surface. The course number system increases by intervals longitudinally following each set of the scale numbers, representing the horizontal rows of bricks, stones, or masonry units that are laid in a wall or structure. Each course represents one row of masonry units that are stacked horizontally on top of the previous course.

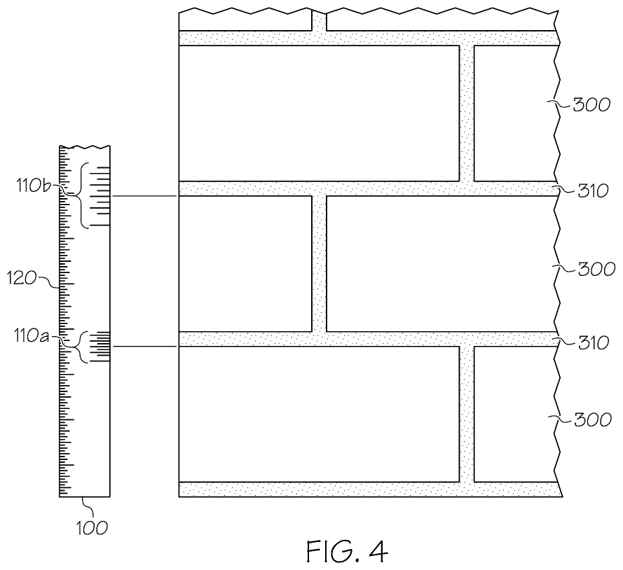

The spacing number of each of the first set of markings 110 shows a scale number which represents a distance between bricks and mortar, with 1 representing the smallest joint distance and 0 representing the largest joint distance. The second subset of markings 110b is spaced apart from each other further than the first subset of markings 110a because the spacing of the second subset of markings 110b accounts for two courses worth of mortar spacing while the first subset of markings 110a accounts for only one layer of mortar (described more particularly with respect to FIG. 4). For example, the spacings between the first course number markings 1 is smaller than the second course number markings 2.

While only three subsets 110a, 110b, 110c (i.e. course numbers 1-3) are depicted in the Figures (and only two in the enlarged view of FIG. 3), the adhesive masonry tape 100 may include many subsets/courses. At higher subsets, the individual lines of the courses begin to overlap—i.e. the largest spacing number of 0 of a lower course number (e.g., 5) may be higher on the adhesive masonry tape 100 than the smallest spacing number 1 of a higher course number (e.g., 6). Thus, the course number keeps track of how many bricks have been placed below the individual line or marking. As described hereinabove, the first set of markings 110 may correspond to the markings located on a brick mason wood ruler (i.e. Lufkin ruler).

While only the first two courses are shown, it should be understood that the adhesive masonry tape 100 may comprise any number of courses over any amount of length (e.g., 6 feet of length). In a 6 feet embodiment, the tape may further be configured to “restart” or repeat the markings at regular intervals (i.e. every 6 feet, for example). There may be an empty spacing located between each marking restart (i.e. every 6 feet of tape) to accommodate tearing of the tape. Various other restarting lengths are contemplated, such as 8 feet or 10 feet. However, because a standard masonry Lufkin ruler is 6 feet in length, a preferred embodiment may restart the spacing markings every 6 feet. While not shown, a “staring line” may be printed on the adhesive masonry tape 100 to denote and/or align with the bottom of the first brick and/or course.

Unlike the standard joint thickness (having ten distinct distances or spacings per course number), the oversize joint thickness tape includes eleven different graduations or spacings. A modular spacing thickness tape may include six different graduations, for example, per course number. Thus, the number of distinct spacings may be increased or decreased from the embodiments shown.

FIG. 4 depicts a side schematic view of the adhesive masonry tape 100 in FIG. 1, in accordance with one embodiment. Depicted is the tape 100 adhered to a wall where bricks 300 are being laid. The adhesive masonry tape 100 may be applied to a base or ground level upon which the masonry project will be laid. While not shown, the tape 100 may also be attached to a story poll, or the like. As shown, first a layer of mortar 310 is applied at a ground level below the first course or brick 300. Next the first course of bricks 30 is laid to a spacing number of 5, within the first subset of markings 110a (i.e. course number 1) denoting the spacing number. Once laid, another layer of mortar 310 is applied above the first course of bricks 300. Then, the second course of bricks 300 is laid above the first course to the same spacing number 5 within the second subsets of markings 110b (i.e. course number 2). This process may continue for each course of bricks, each course being laid to the spacing number 5 to maintain consistency of spacing. While not shown, the spacing number 5 of the third, fourth, fifth, etc. courses (course numbers 3, 4, 5, etc.) will also align with the proper location of the bottom of each brick of the next successive brick. Thus, the marking for the spacing number 5 for each course ensures that the width of each course is evenly spaced over any number of courses. Further, while the embodiment shown is aligned with the “spacing number 5” (i.e. a middle gap), the gap of the mortar 310 could be widened or narrowed if higher or lower spacing numbers are used. Thus, always using spacing number 8 for each course will result in a wider but still equally consistent gap between the bricks, for example.

The markings 110, 111, 120 may be applied to a surface of the adhesive masonry tape 100 via a printing process prior to a rolling process, and/or an adhesive application process, for example. Any type of printing process may be contemplated for printing the markings 110, 111, 120 on the adhesive masonry tape 100.

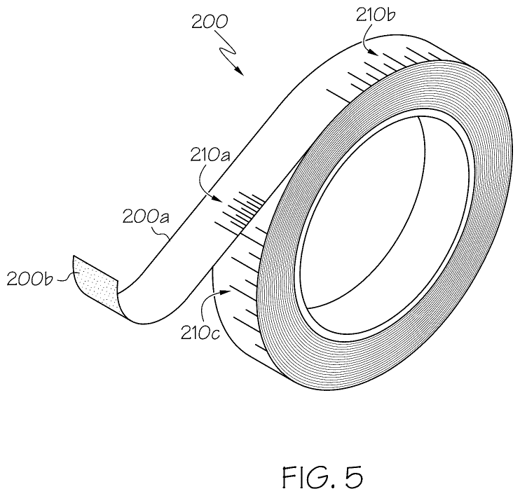

FIG. 5 depicts a perspective view of another adhesive masonry tape 200, in accordance with one embodiment. The adhesive masonry tape 200 may be the same or similar to the adhesive masonry tape 100 in most respects, including the marking scheme. However, unlike the adhesive masonry tape 100, the adhesive masonry tape 200 may not include a peelable backing 100c. Rather, the adhesive masonry tape 200 may include a tape substrate 200a on top of an adhesive backing 200b, without the additional peelable backing 100c shown in FIG. 2. Instead, the masonry tape 200 may be rolled such that the adhesive backing 200b of the tape substrate 200a sticks directly to another layer of the tape substrate 200a during rolling.

Methods of employing the adhesive masonry tape in brick laying are also contemplated. These methods can be executed in any sequence or even simultaneously, provided the functionality of the invention is not compromised. Similarly, methods contemplated herein may incorporate any combination of the described features and embodiments, as long as it remains functional and effective for its intended use. For example, a method of employing the adhesive masonry tape may include determining the height of the wall to build and tearing off the tape to the corresponding to the height and placing the tape vertically on a wall to be covered by bricks. In some embodiments, a single piece of tape may be sufficient. In other embodiments, the method may include utilizing a plurality of different tapes spaced apart horizontally on the wall.

The method may include laying each course of the bricks horizontally to fit the desired distance for each brick layer. In particular, the method may include determining the corresponding spacing number (i.e. how thick the mortar joint should be). The method may then include using the determined spacing number when determining a joint thickness of mortar between courses and laying the mortar and the second layer of bricks on top of the first layer. The method may include repeating the alignment with the brick and the scale number until the desired height of the wall is reached.

While various examples have been shown and described, the description is intended to be exemplary, rather than limiting and it should be understood by those of ordinary skill in the art that various changes in form and detail may be made therein without departing from the scope of the invention as recited in the accompanying claims.

I claim:

1. An adhesive masonry tape for use in brick laying, comprising:
an elongated tape substrate with adhesive properties on one side; and
a first set of markings designating a joint thickness for mortar placement between bricks.

2. The adhesive masonry tape of claim 1, further comprising:
a second set of markings along the length of the tape, the second markings indicating units of length; and
the second set of markings repeating in regular intervals.

3. The adhesive masonry tape of claim 1, wherein the first set of markings includes a plurality of lines, wherein each of the plurality of lines includes a spacing number.

4. The adhesive masonry tape of claim 3, wherein each of the plurality of lines includes a course number.

5. The scale numerical system of claim 4, wherein the spacing system corresponds to common joint distances between bricks and mortar, wherein the scale numbers range from 1 to 0, with 1 representing the smallest joint distance and 0 representing the largest joint distance.

6. The adhesive masonry tape of claim 4, wherein the course number is adjacent to the spacing number on each of the plurality of lines.

7. The adhesive masonry tape of claim 6, wherein the course number is rotated relative to the spacing number for each of the plurality of lines.

8. The adhesive masonry tape of claim 1, further comprising a top printed tape substrate, an adhesive layer and a backing layer.

9. The adhesive masonry tape of claim 1, further comprising a top printed tape substrate on top of an adhesive layer and without a backing layer.

10. The adhesive masonry tape of claim 3, wherein the spacing numbers define modular brick spacings.

11. The adhesive masonry tape of claim 3, wherein the spacing numbers define standard brick spacings.

12. The adhesive masonry tape of claim 3, wherein the spacing numbers define oversized brick spacings.

13. The adhesive masonry tape of claim 1, wherein the tape is made of water-resistant material.

14. The adhesive masonry tape of claim 1, further comprising a length of tape including a plurality of repeats of the first set of markings.

15. The adhesive masonry tape of claim 13, wherein each of the plurality of repeats of the first set of markings is 6 feet in length.

16. The adhesive masonry tape of claim 13, further comprising an empty spacing located between each of the plurality of repeats of the first set of markings.

17. The adhesive masonry tape of claim 15, further comprising a starting line located at the base of each of the plurality of repeats of the first set of markings located after the empty space.

18. The adhesive masonry tape of claim 1, wherein the elongated tape substrate is configured to be flexible to bending.

19. The adhesive masonry tape of claim 1, wherein the elongated tape substrate is configured to be resistant to stretching.

20. A method for employing adhesive masonry tape in brick laying, comprising the following steps:
providing the adhesive masonry tape of claim 1;
laying the adhesive masonry tape on a wall or story pole vertically;
tearing off a desired length of the adhesive masonry tape;
placing a first brick layer adjacent to the tape;
laying a first layer of mortar above the first brick layer using the set of markings designating the joint thickness for mortar placement; and
placing a second brick layer above the first layer of mortar.
